(19) United States
(12) Patent Application Publication
(10) Pub. No.: US 2005/0007403 A1
(43) Pub. Date: Jan. 13, 2005

(54) PRINTING APPARATUS AND METHOD FOR MAINTAINING TEMPERATURE OF A PRINTHEAD

(76) Inventors: Cheng-Lung Lee, Taipei City (TW); Chien-Hsien Ho, I-Lan City (TW); Shih-Yen Chang, Taipei City (TW); Chien-Chih Huang, Tai-Chung Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/604,253

(22) Filed: Jul. 7, 2003

(51) Int. Cl. B41J 29/38

(52) U.S. Cl. 347/12

(57) ABSTRACT

A printing apparatusincludes a printhead for ejecting ink from a plurality of nozzles and a signal generator for generating printing pulses and non-printing pulses used to control heaters. The printing pulses control the heaters to generate sufficient heat energy to eject ink from the nozzles for printing data, and the non-printing pulses control the heaters to generate heat energy that is not sufficient to eject ink from the nozzles for raising a temperature of the ink. The printing apparatus also includes a print data comparator for comparing a percentage of data printed during a predetermined period of time with a threshold value, anda control circuit for varying the non-printing pulses generated by the signal generator according to the percentage of data printed during the predetermined period of time and the threshold value.

### BACKGROUND OF INVENTION

1. Field of the Invention

The present invention relates to a printhead of a printing apparatus, and more specifically, to a method for maintaining a temperature of the printhead according to an amount of data printed and a temperature of the print-head.

2. Description of the Prior Art

An inkjet printer forms a printed image by printing a pattern of individual dots at particular locations of an array defined for the printing medium. The locations are conveniently visualized as being small dots in a rectilinear array, and will be referred to as dot locations. Thus, the printing operation can be viewed as the filling of a pattern of dot locations with dots of ink.

Inkjet printers print dots by ejecting very small drops of ink onto the print medium, and typically include a movable carriage that supports one or more printheads, each having ink ejecting nozzles. The carriage traverses over the surface of the print medium, and the nozzles are controlled to eject drops of ink at appropriate times pursuant to command of a microcomputer or other controller, wherein the timing of the application of the ink drops is intended to correspond to the pattern of dot locations of the image being printed.

Color inkjet printers commonly employ a plurality of printheads, for example four, mounted in the print carriage to produce different colors. Each printhead contains ink of a different color, with the commonly used colors being cyan, magenta, yellow, and black. These base colors are produced by depositing a drop of the required color onto a dot location, while secondary or shaded colors are formed by depositing multiple drops of different base color inks onto the same dot location, with the overprinting of two or more base colors producing secondary colors according to well established optical principles.

The typical inkjet printhead (i.e., the silicon substrate, structures built on the substrate, and connections to the substrate) uses liquid ink (i.e., colorants dissolved or dispersed in a solvent). It has an array of precisely formed nozzles attached to a printhead substrate that incorporates an array of firing chambers which receive liquid ink from the ink reservoir. Each chamber has a thin-film resistor, known as an inkjet firing chamber resistor, located near the nozzle so ink can collect between it and the nozzle. When electric printing pulses heat the inkier firing chamber resistor, a small portion of the ink next to it vaporizes and ejects a drop of ink from the printhead. Properly arranged nozzles form a dot matrix pattern. Properly sequencing the operation of each nozzle causes characters or images to be printed upon the paper as the printhead moves past the paper.

Print quality is one of the most important considerations of competition in the color inkier printer field. Since the image output of a color inkier printer is formed of thousands of individual ink drops, the quality of the image is ultimately dependent upon the quality of each ink drop and the arrangement of the ink drops on the print medium. One source of print quality degradation is improper ink drop volume.

Drop volume variations result in degraded print quality and have prevented the realization of the full potential of inkjet printers. Drop volumes vary with the printhead substrate temperature because the two properties that control it vary with printhead substrate temperature: the viscosity of the ink and the amount of ink vaporized by a firing chamber resistor when driven with a printing pulse. Drop volume variations commonly occur during printer startup, during changes in ambient temperature, and when the printer output varies, such as a change from normal print to “black-out” print (i.e. where the printer covers the page with dots.)

Variations in drop volume degrades print quality by causing variations in the darkness of black-and-white text, variations in the contrast of gray-scale images, and variations in the chroma, hue and lightness of color images. The chroma, hue and lightness of a printed color depends on the volume of all the primary color drops that create the printed color. If the printhead substrate temperature increases or decreases as the page is printed, the colors at the top of the page can differ from the colors at the bottom of the page. Reducing the range of drop volume variations will improve the quality of printed text, graphics, and images.

Additional degradation in the print quality is caused by excessive amounts of ink in the larger drops. When at room temperature, an inkjet printhead must eject drops of sufficient size to form satisfactory printed dots. However, previously known printheads that meet this performance requirement eject drops containing excessive amounts of ink when the printhead substrate is warm. The excessive ink degrades the print by causing feathering of the ink drops, bleeding of ink drops having different colors, and cockling and curling of the paper. Reducing the range of drop volume variation would help eliminate this problem.

Inkjet cartridge performance can vary widely due to the temperature of the ink firing chamber and therefore the ejected ink. Due to changes of the physical constants of the ink, the nucleation dynamics and the refill characteristics of an inkjet printhead due to substrate temperature, the control of the temperature is necessary to guarantee consistently good image print quality. The cartridge substrate temperature can vary due to ambient temperature, servicing (spitting) and the amount of printing done with the cartridge.

### SUMMARY OF INVENTION

It is therefore a primary objective of the claimed invention to provide a printing apparatus and method of maintaining a temperature of a printhead according to an amount of data printed and a temperature of the printhead in order to solve the above-mentioned problems.

According to the claimed invention, a printing apparatus-includes a printhead for ejecting ink from a plurality of nozzles. The printhead contains a substrate anda plurality of heaters arranged on the substrate for heating ink in the printhead to generate bubbles in the ink and eject the ink through the corresponding nozzles. The printing apparatus also includes a signal generator for generating printing pulses and non-printing pulses used to control the heaters, the printing pulses controlling the heaters to generate sufficient heat energy to eject ink from the nozzles for printing data, and the non-printing pulses controlling the heaters to generate heat energy that is not sufficient to eject ink from the nozzles for raising a temperature of the ink;a print data comparator for comparing a percentage of data printed during a predetermined period of time with a threshold value; anda control circuit for varying the non-printing pulses generated by the signal generator according to the percentage of data printed during the predetermined period of time and the threshold value.

It is an advantage of the claimed invention that the present invention compares the percentage of data printed during the predetermined period of time with the threshold value for properly maintaining the temperature of the printhead according to an amount of data printed.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a perspective diagram of an ink jet cartridge according to the present invention.

FIG. 2 is a functional block diagram of the cartridge connected to a printer system according to the present invention.

FIG. 3 shows variations of non-printing pulses according to the present invention.

FIG. 4 shows variations of non-printing pulses printed before or after a printing pulse according to the present invention.

FIG. 5 is a flowchart illustrating the present invention method for controlling non-printing pulses according to the percentage of data printed during the predetermined period of time.

FIG. 6 is a flowchart illustrating the present invention method for controlling non-printing pulses according to the substrate temperature.

FIG. 7 is a graph illustrating a relationship between non-printing pulses and the percentage of data printed during the predetermined period of time.

FIG. 8 is a graph illustrating a relationship between a width of non-printing pulses and the percentage of data printed during the predetermined period of time.

FIG. 9 is a graph illustrating a relationship between non-printing pulses and the substrate temperature.

FIG. 10 is a diagram showing a non-printing pulse being split up into a plurality of smaller non-printing pulses.

### DETAILED DESCRIPTION

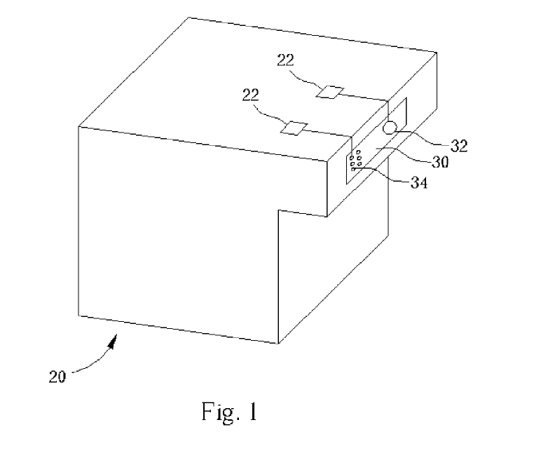

Please refer to FIG. 1. FIG. 1 is a perspective diagram of an ink jet cartridge 20 according to the present invention. The cartridge 20 contains a printhead 30 for printing ink on a medium, the printhead 30 being formed on a substrate. The printhead 30 contains a temperature sensor 32 for measuring a temperature of the substrate of the print-head 30 and a plurality of nozzles 34 for ejecting ink from the cartridge 20. The nozzles 34 and the temperature sensor 32 are each connected to a contact point 22. The contact points 22 are used to communicate with a printer system that the cartridge 20 is placed in.

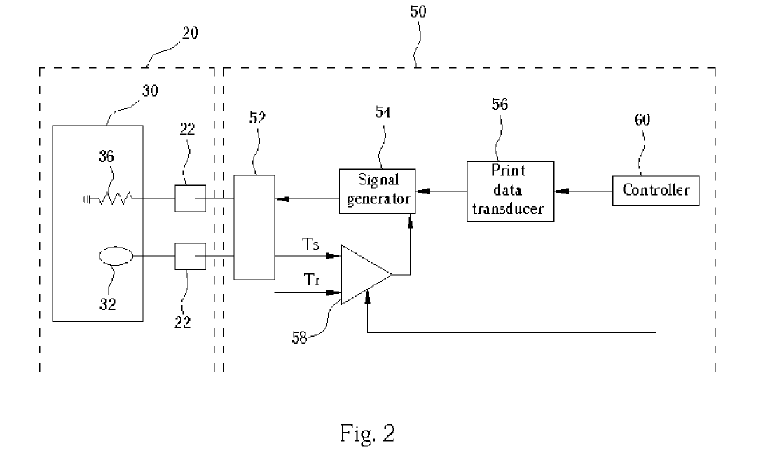

Please refer to FIG. 2. FIG. 2 is a functional block diagram of the cartridge 20 connected to a printer system 50 according to the present invention. The printhead 30 further comprises a plurality of heaters 36 for heating up ink inside the cartridge 20, and for creating bubbles in the ink to cause ink to eject from the corresponding nozzles 34. The cartridge 20 is connected to the printer system 50 through a connection between the contact points 22 of the cartridge 20 and a contact port 52 of the printer system 50.

The printer system 50 contains a signal generator 54 for generating printing pulses and non-printing pulses used to control the heaters 36. The printing pulses control the heaters 36 to generate sufficient heat energy to eject ink from the nozzles 34 for printing data, whereas the non-printing pulses control the heaters 36 to generate heat energy that is not sufficient to eject ink from the nozzles 34 for raising a temperature of the ink. The printer system 50 also contains a print data transducer 56 for translating raw data into printing data and sending the printing data to the signal generator 54. The print data transducer 56 can also calculate a percentage of data printed during a predetermined period of time, with 0% representing no dots printed and 100% representing all black (completely covered with dots).

The printer system 50 also contains a comparator 58 for comparing a substrate temperature Ts with a reference temperature Tr. A controller 60 is used to control operation of the printer system 50. The main objective of the present invention includes using the controller 60 to control the non-printing pulses generated by the signal generator 54 for changing a temperature of the substrate (and ultimately the temperature of the ink). As will be explained below, the controller 60 uses two criteria: the percentage of data printed during the predetermined period of time and a difference between the substrate temperature Ts and the reference temperature Tr.

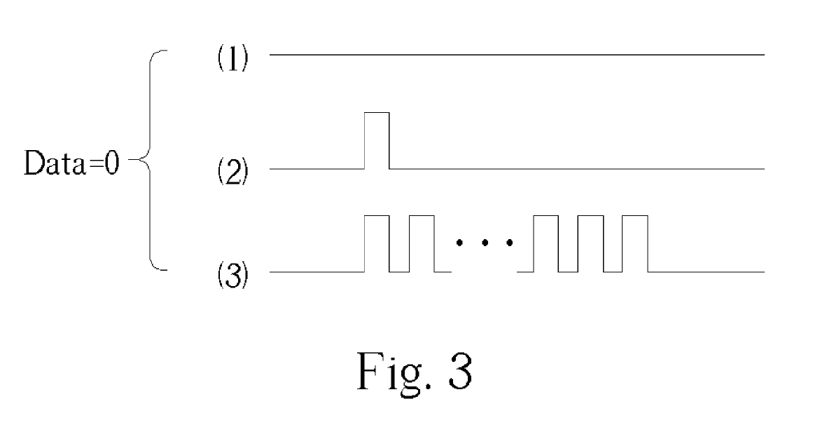

Please refer to FIG. 3. FIG. 3 shows variations of non-printing pulses according to the present invention. Three variations are shown, and each of these shows a case where no data is to be printed. Signal number one shows a case where no non-printing pulses are needed for raising the substrate temperature Ts. Signal number two shows a case where one non-printing pulse is needed for raising the substrate temperature Ts by a small amount. Signal number three shows a case where many non-printing pulses are needed for raising the substrate temperature Ts by a large amount.

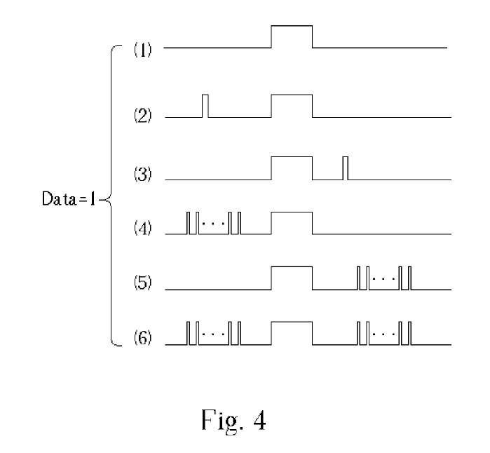

Please refer to FIG. 4. FIG. 4 shows variations of non-printing pulses printed before or after a printing pulse according to the present invention. Six variations are shown, and each of these shows a case where data is to be printed. Signal number one shows a case where a printing pulse is generated, and no non-printing pulses are needed for further raising the substrate temperature Ts. Signal number two shows a case where a printing pulse is generated, and one non-printing pulse is needed for raising the substrate temperature Ts. The non-printing pulse occurs before the printing pulse, and is also referred to as a pre-pulse. Signal number three also shows a case where a printing pulse is generated, and one non-printing pulse is needed for raising the substrate temperature Ts. This time the non-printing pulse occurs after the printing pulse, and is also referred to as a post-pulse. Signal number four shows a case where many pre-pulses are used for raising the substrate temperature Ts, and signal number five shows a case where many post-pulses are used for raising the substrate temperature Ts. Finally, signal number six shows a case where many pre-pulses and post-pulses are used for raising the substrate temperature Ts.

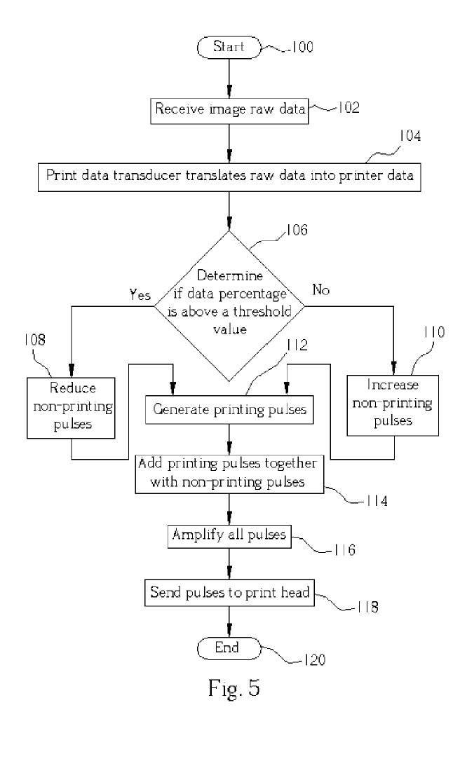

Please refer to FIG. 5. FIG. 5 is a flowchart illustrating the present invention method for controlling non-printing pulses according to the percentage of data printed during the predetermined period of time. Steps contained in the flowchart will be explained below.

Step 100:Start;

Step 102:The print data transducer 56 receives image raw data;

Step 104:The print data transducer 56 translates the raw data into printer data for providing information about which dots should be printed;

Step 106:Determine if the percentage of data printed during the predetermined period of time is above a threshold value, such as 80%; if so, go to step 108; if not, go to step 110;

Step 108:Use the controller 60 to reduce the non-printing pulses generated by the signal generator 54; the frequency of the pulses, the number of pulses, the width or duty cycle of the pulses, or the height of the pulses can all be reduced to achieve this goal; the amount of the reduction depends on the difference between the measured percentage of data and the threshold value; go to step 112;

Step 110:Use the controller 60 to increase the non-printing pulses generated by the signal generator 54; the frequency of the pulses, the number of pulses, the width or duty cycle of the pulses, or the height of the pulses can all be increased to achieve this goal; the amount of the increase depends on the difference between the measured percentage of data and the threshold value;

Step 112:The signal generator 54 generates printing pulses according to the printer data provided by the print data transducer 56;

Step 114:The printing pulses and the non-printing pulses are added together for producing a combined printing signal;

Step 116:The combined printing signal is amplified;

Step 118:The amplified combined printing signal is sent to the printhead 30, where data is printed according to the printing pulses and the printhead 30 is warmed according to the non-printing pulses; and

Step 120:End.

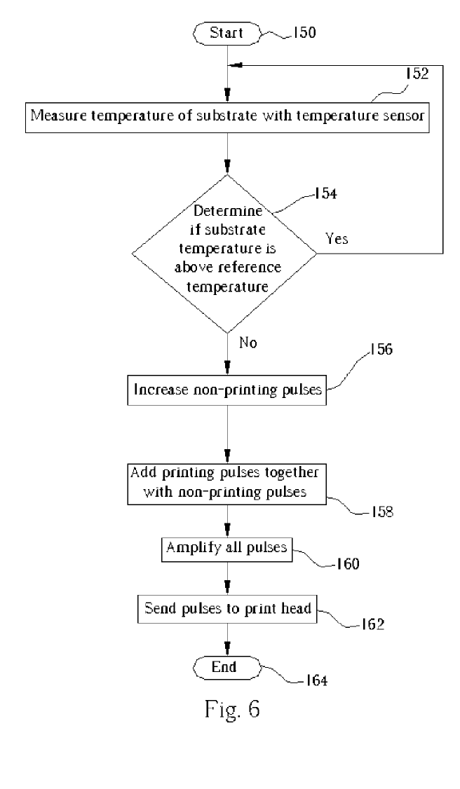

Please refer to FIG. 6. FIG. 6 is a flowchart illustrating the present invention method for controlling non-printing pulses according to the substrate temperature Ts. Steps contained in the flowchart will be explained below.

Step 150:Start;

Step 152:Measure the substrate temperature Ts with the temperature sensor 32;

Step 154:Use the comparator 58 to determine if the substrate temperature Ts is above the reference temperature Tr; if so, go to step 152; if not, go to step 156;

Step 156:Since the substrate temperature Ts is not above the reference temperature Tr, use the controller 60 to increase the non-printing pulses generated by the signal generator 54; the frequency of the pulses, the number of pulses, the width or duty cycle of the pulses, or the height of the pulses can all be increased to achieve this goal; the amount of the increase depends on the difference between the measured substrate temperature Ts and the reference temperature Tr;

Step 158:The printing pulses and the non-printing pulses are added together for producing a combined printing signal;

Step 160:The combined printing signal is amplified;

Step 162:The amplified combined printing signal is sent to the printhead 30, where data is printed according to the printing pulses and the printhead 30 is warmed according to the non-printing pulses; and

Step 164:End.

If a high percentage of data is printed during the predetermined period of time, the printhead 30 will be very active and the substrate temperature Ts will be higher than normal. Therefore, few if any non-printing pulses will be needed for raising the substrate temperature Ts. On the other hand, if a low percentage of data is printed during the predetermined period of time, the printhead 30 will be less active and the substrate temperature Ts will be lower than normal. That means a large amount of non-printing pulses will be needed for raising the substrate temperature Ts.

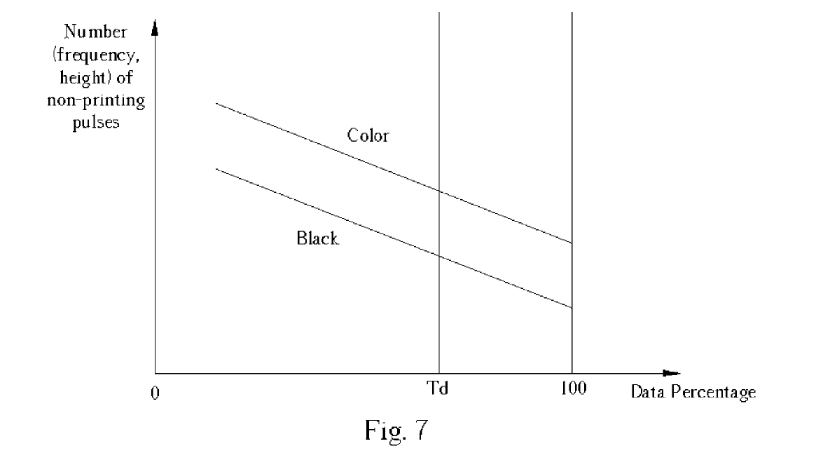

Please refer to FIG. 7. FIG. 7 is a graph illustrating a relationship between non-printing pulses and the percentage of data printed during the predetermined period of time. The vertical axis of FIG. 7 can represent the frequency, number, or height of the non-printing pulses, where the height can be varied by changing a voltage supplied to the non-printing pulses. The horizontal axis of FIG. 7 represents the data percentage during the predetermined period of time. The graph shows an inverse relation between the percentage of data printed during the predetermined period of time and the non-printing pulses needed to warm the printhead 30 for both color dots and black dots printed. The threshold value Td is equal to a predetermined percentage of data printed, and can be used as a reference for the controller 60 to decide if the non-printing pulses should be increased or decreased. Please note that the relationship shown in FIG. 7 does not have to be an inverse linear relationship. Any relationship in which the non-printing pulses are decreased or held steady as the percentage of data within the predetermined period of time is increased falls within the scope of the present invention.

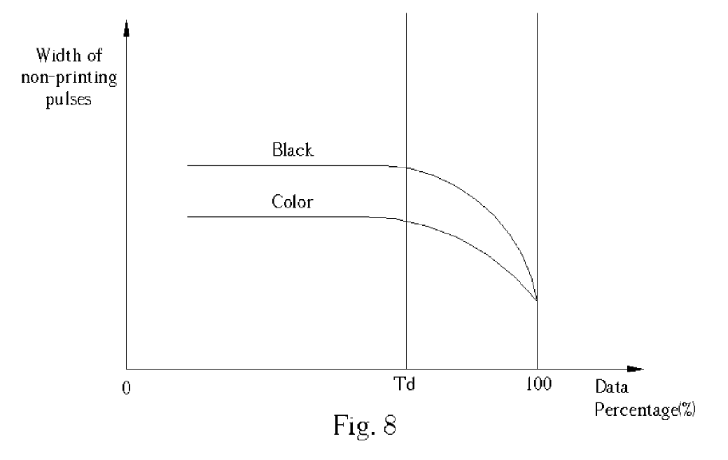

Please refer to FIG. 8. FIG. 8 is a graph illustrating a relationship between a width of non-printing pulses and the percentage of data printed during the predetermined period of time. The vertical axis of FIG. 8 represents the width or duty cycle of the non-printing pulses. Like FIG. 7, the horizontal axis of FIG. 8 represents the data percentage during the predetermined period of time. FIG. 8 also shows an inverse relation between the percentage of data printed during the predetermined period of time and the width of non-printing pulses needed to warm the printhead 30 for both color dots and black dots printed. The graph shown in FIG. 8 only serves as an example, and any relationship in which the width of non-printing pulses is decreased or held steady as the percentage of data within the predetermined period of time is increased falls within the scope of the present invention.

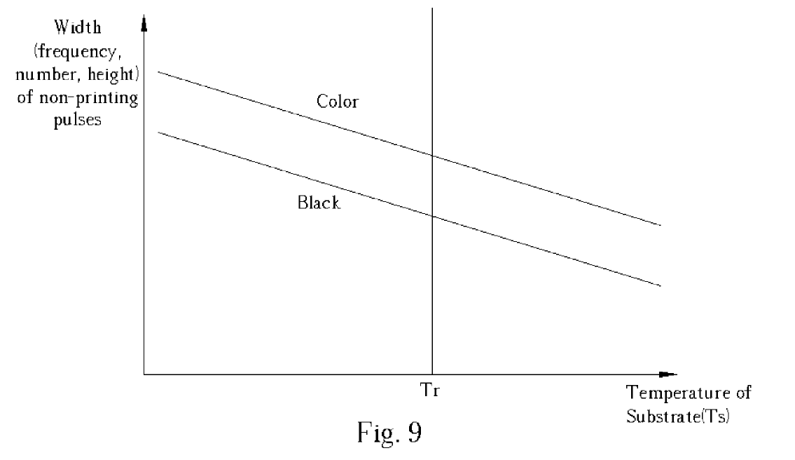

Please refer to FIG. 9. FIG. 9 is a graph illustrating a relationship between non-printing pulses and the substrate temperature Ts. The vertical axis of FIG. 9 can represent the frequency, number, the width or duty cycle, or height of the non-printing pulses. The horizontal axis of FIG. 9 represents the substrate temperature Ts. The graph shows an inverse relation between the substrate temperature Ts and the non-printing pulses needed to warm the printhead 30 for both color dots and black dots printed. The reference temperature Tr is used as a reference for the controller 60 to decide if the non-printing pulses should be increased or decreased. Please note that the relationship shown in FIG. 9 does not have to be an inverse linear relationship. Any relationship in which the non-printing pulses are decreased or held steady as the substrate temperature Ts is increased falls within the scope of the present invention.

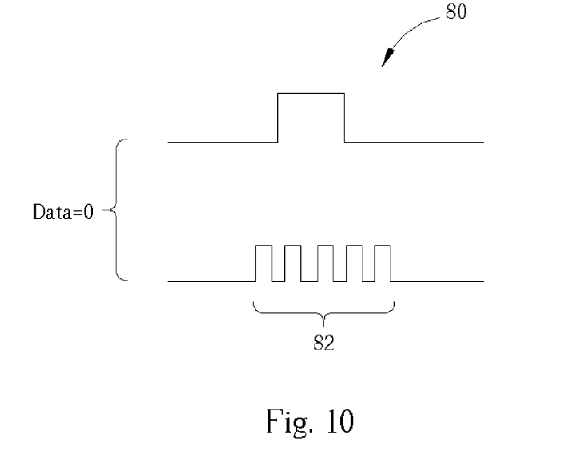

Please refer to FIG. 10. FIG. 10 is a diagram showing a non-printing pulse 80 being divided into a plurality of smaller non-printing pulses 82. The non-printing pulse 80 is shown as having an exaggerated width for clearly illustrating the benefit of splitting the non-printing pulse 80 into the plurality of smaller non-printing pulses 82. By dividing the non-printing pulse 80, the controller 60 can reduce an instantaneous power requirement of the printer system 50 by spreading the required energy over a larger period of time.

In contrast to the prior art, the present invention uses the controller 60 for adjusting the non-printing pulses generated by the signal generator 54 and sent to the printhead 30. The non-printing pulses are adjusted according to the percentage of data printed during the predetermined period of time and according to the substrate temperature Ts as compared to the reference temperature Tr.

Those skilled in the art will readily observe that numerous modifications and alterations of the device may be made while retaining the teachings of the invention. Accordingly, the above disclosure should be construed as limited only by the metes and bounds of the appended claims.

1. A printing apparatus comprising:
a printhead for ejecting ink from a plurality of nozzles, the printhead comprising:
a substrate; and
a plurality of heaters arranged on the substrate for heating ink in the printhead to generate bubbles in the ink and eject the ink through the corresponding nozzles;
a signal generator for generating printing pulses and non-printing pulses used to control the heaters, the printing pulses controlling the heaters to generate sufficient heat energy to eject ink from the nozzles for printing data, and the non-printing pulses controlling the heaters to generate heat energy that is not sufficient to eject ink from the nozzles for raising a temperature of the ink;
a print data comparator for comparing a percentage of data printed during a predetermined period of time with a threshold value; and
a control circuit for varying the non-printing pulses generated by the signal generator according to the percentage of data printed during the predetermined period of time and the threshold value.

2. The printing apparatus of claim 1 wherein if the percentage of data printed during the predetermined period of time is above the threshold value, a width of the non-printing pulses generated by the signal generator is lowered, and if the percentage of data is below the threshold value, the width of the non-printing pulses generated by the signal generator is raised.

3. The printing apparatus of claim 1 wherein the control circuit varies a frequency of the non-printing pulses generated by the signal generator according to the percentage of data printed during the predetermined period of time, wherein if the percentage of data is above the threshold value, the frequency of the non-printing pulses generated by the signal generator is lowered, and if the percentage of data is below the threshold value, the frequency of the non-printing pulses generated by the signal generator is raised.

4. The printing apparatus of claim 1 wherein the control circuit varies a number of the non-printing pulses generated by the signal generator according to the percentage of data printed during the predetermined period of time, wherein if the percentage of data is above the threshold value, the number of the non-printing pulses generated by the signal generator is lowered, and if the percentage of data is below the threshold value, the number of the non-printing pulses generated by the signal generator is raised.

5. The printing apparatus of claim 1 wherein the control circuit varies a voltage of the non-printing pulsesgenerated by the signal generator according to the percentage of data printed during the predetermined period of time, wherein if the percentage of data is above the threshold value, the voltage of the non-printing pulses generated by the signal generator is lowered, and if the percentage of data is below the threshold value, the voltage of the non-printing pulses generated by the signal generator is raised.

6. The printing apparatus of claim 1 wherein the printhead further comprises a temperature sensor for measuring a temperature of the substrate and a temperature comparator for comparing the temperature of the substrate with a reference temperature.

7. The printing apparatus of claim 6 wherein the control circuit varies a frequency of the non-printing pulses generated by the signal generator according to a temperature difference between the temperature of the substrate and the reference temperature, wherein if the temperature of the substrate is above the reference temperature, the frequency of the non-printing pulses generated by the signal generator is lowered, and if the temperature of the substrate is below the reference temperature, the frequency of the non-printing pulses generated by the signal generator is raised.

8. The printing apparatus of claim 6 wherein the control circuit varies a width of the non-printing pulses generated by the signal generator according to a temperature difference between the temperature of the substrate and the reference temperature, wherein if the temperature of the substrate is above the reference temperature, the width of the non-printing pulses generated by the signal generator is lowered, and if the temperature of the substrate is below the reference temperature, the width of the non-printing pulses generated by the signal generator is raised.

9. The printing apparatus of claim 6 wherein the control circuit varies a number of the non-printing pulses generated by the signal generator according to a temperature difference between the temperature of the substrate and the reference temperature, wherein if the temperature of the substrate is above the reference temperature, the number of the non-printing pulses generated by the signal generator is lowered, and if the temperature of the substrate is below the reference temperature, the number of the non-printing pulses generated by the signal generator is raised.

10. The printing apparatus of claim 6 wherein the control circuit varies a voltage of the non-printing pulses generated by the signal generator according to a temperature difference between the temperature of the substrate and the reference temperature, wherein if the temperature of the substrate is above the reference temperature, the voltage of the non-printing pulses generated by the signal generator is lowered, and if the temperature of the substrate is below the reference temperature, the voltage of the non-printing pulses generated by the signal generator is raised.

11. A printing apparatus comprising:
a printhead for ejecting ink from a plurality of nozzles, the printhead comprising:
a substrate; and
a plurality of heaters arranged on the substrate for heating ink in the printhead to generate bubbles in the ink and eject the ink through the corresponding nozzles;
a signal generator for generating printing pulses and non-printing pulses used to control the heaters, the printing pulses controlling the heaters to generate sufficient heat energy to eject ink from the nozzles for printing data, and the non-printing pulses controlling the heaters to generate heat energy that is not sufficient to eject ink from the nozzles for raising a temperature of the ink;
a temperature sensor for measuring a temperature of the substrate;
a temperature comparator for comparing the temperature of the substrate with a reference temperature; and
a control circuit for varying the non-printing pulses generated by the signal generator according to a temperature difference between the temperature of the substrate and the reference temperature.

12. The printing apparatus of claim 11 wherein if the temperature of the substrate is above the reference temperature, avoltage of the non-printing pulses generated by the signal generator is lowered, and if the temperature of the substrate is below the reference temperature, the voltage of the non-printing pulses generated by the signal generator is raised.

13. The printing apparatus of claim 11wherein the control circuit varies a width of the non-printing pulses generated by the signal generator according to a temperature difference between the temperature of the substrate and the reference temperature, wherein if the temperature of the substrate is above the reference temperature, the width of the non-printing pulses generated by the signal generator is lowered, and if the temperature of the substrate is below the reference temperature, the width of the non-printing pulses generated by the signal generator is raised.

14. The printing apparatus of claim 11wherein the control circuit varies a number of the non-printing pulses generated by the signal generator according to a temperature difference between the temperature of the substrate and the reference temperature, wherein if the temperature of the substrate is above the reference temperature, the number of the non-printing pulses generated by the signal generator is lowered, and if the temperature of the substrate is below the reference temperature, the number of the non-printing pulses generated by the signal generator is raised.

15. The printing apparatus of claim 11 wherein the control circuit varies a frequency of the non-printing pulses generated by the signal generator according to a temperature difference between the temperature of the substrate and the reference temperature, wherein if the temperature of the substrate is above the reference temperature, the frequency of the non-printing pulses generated by the signal generator is lowered, and if the temperature of the substrate is below the reference temperature, the frequency of the non-printing pulses generated by the signal generator is raised.

16. A method for heating a printhead in a printing apparatus, the method comprising the steps of:
providing a printing apparatus, including:
a printhead for ejecting ink from a plurality of nozzles, the printhead comprising:
a substrate; and
a plurality of heaters arranged on the substrate for heating ink in the printhead to generate bubbles in the ink and eject the ink through the corresponding nozzles;
generating printing pulses and non-printing pulses used to control the heaters, the printing pulses controlling the heaters to generate sufficient heat energy to eject ink from the nozzles for printing data, and the non-printing pulses controlling the heaters to generate heat energy that is not sufficient to eject ink from the nozzles for raising a temperature of the ink;
comparing a percentage of data printed during a predetermined period of time with a threshold value; and
varying the non-printing pulses according to the percentage of data printed during the predetermined period of time and the threshold value.

17. The method of claim 16 further comprising lowering a width of the non-printing pulses if the percentage of data printed during the predetermined period of time is above the threshold value, and raising the width of the non-printing pulses if the percentage of data printed during the predetermined period of time is below the threshold value.

18. The method of claim 16 further comprising lowering a frequency of the non-printing pulses if the percentage of data printed during the predetermined period of time is above the threshold value, and raising the frequency of the non-printing pulses if the percentage of data printed during the predetermined period of time is below the threshold value.

19. The method of claim 16 further comprising lowering a number of the non-printing pulses if the percentage of data printed during the predetermined period of time is above the threshold value, and raising the number of the non-printing pulses if the percentage of data printed during the predetermined period of time is below the threshold value.

20. The method of claim 16 further comprising lowering a voltage of the non-printing pulses if the percentage of data printed during the predetermined period of time is above the threshold value, and raising the voltage of the non-printing pulses if the percentage of data printed during the predetermined period of time is below the threshold value.

21. A method for heating a printhead in a printing apparatus, the method comprising the steps of:
providing a printing apparatus, including:
a printhead for ejecting ink from a plurality of nozzles, the printhead comprising:
a substrate; and
a plurality of heaters arranged on the substrate for heating ink in the printhead to generate bubbles in the ink and eject the ink through the corresponding nozzles;
generating printing pulses and non-printing pulses used to control the heaters, the printing pulses controlling the heaters to generate sufficient heat energy to eject ink from the nozzles for printing data, and the non-printing pulses controlling the heaters to generate heat energy that is not sufficient to eject ink from the nozzles for raising a temperature of the ink;
measuring a temperature of the substrate;
comparing the temperature of the substrate with a reference temperature; and
varying the non-printing pulses according to a temperature difference between the temperature of the substrate and the reference temperature.

22. The method of claim 21 further comprising lowering avoltage of the non-printing pulses if the temperature of the substrate is above the reference temperature, and raising the voltage of the non-printing pulses if the temperature of the substrate is below the reference temperature.

23. The method of claim 21 further comprising lowering a width of the non-printing pulsesif the temperature of the substrate is above the reference temperature, and raising the width of the non-printing pulsesif the temperature of the substrate is below the reference temperature.

24. The method of claim 21 further comprising lowering a number of the non-printing pulsesif the temperature of the substrate is above the reference temperature, and raising the number of the non-printing pulsesif the temperature of the substrate is below the reference temperature.

25. The method of claim 21 further comprising lowering a frequency of the non-printing pulsesif the temperature of the substrate is above the reference temperature, and raising the frequency of the non-printing pulsesif the temperature of the substrate is below the reference temperature.
